(19) United States
(12) Patent Application Publication
(10) Pub. No.: US 2015/0324478 A1
(43) Pub. Date: Nov. 12, 2015

(54) DETECTION METHOD AND SCANNING ENGINE OF WEB PAGES

(71) Applicants: BEIJING QIHOO TECHNOLOGY COMPANY LIMITED, Beijing (CN); QIZHI SOFTWARE (BEIJING) COMPANY LIMITED, Beijing (CN)

(72) Inventors: Wu ZHAO, Beijing (CN); Zhuan LONG, Beijing (CN)

(21) Appl. No.: 14/408,948

(22) PCT Filed: May 10, 2013
(86) PCT No.: PCT/CN2013/075483

§ 371 Date: Dec. 17, 2014

(30) Foreign Application Priority Data
Jun. 18, 2012 (CN) 201210207784.6

(51) Int. Cl. G06F 17/30

(52) U.S. Cl. CPC G06F 17/30899; G06F 17/30864

(57) ABSTRACT

The present invention discloses a method for detecting web pages and a scanning engine, wherein the method for detecting web pages comprises: crawling the URL or content of a target web site, determining the web page of the web site by a returned result, and accessing the web page; judging whether the accessed web page conforms to at least one of the following rules: a general exception page rule, a custom exception page rule and a custom exception page behavior rule; if so, determining the accessed web page as an exception page. Through the embodiments of the present invention, the effect of accurately judging the exception pages can be realized.

### TECHNICAL FIELD

The present invention relates to the field of web site security technology, and in particular to a method for detecting web pages and a scanning engine.

### BACKGROUND ART

Vulnerability scanning, usually refers to a security detecting behavior, based on a vulnerability database, by scanning and other means, to detect security vulnerability of a specified remote or local computer system and find out available vulnerabilities. Through the vulnerability scanning, hidden danger and vulnerabilities that may be exploited by a hacker of a computer system or other network equipment can be found in time.

However, the vulnerability scanning products in the prior art often mistake some network error pages for vulnerability when performing vulnerability scanning. For example, 404 Pages, or error web pages intercepted by a firewall or other error pages are mistaken for vulnerabilities, then false positive of the vulnerabilities are generated. A 404 Page is an error web page which frequently appears when accessing web sites. The most common error message is “404 NOT FOUND”. When a user enters a wrong link, a 404 Page appears to inform the user that the requested page does not exist or the link is wrong, and at the same time, guide the user to other pages of the web site, rather than close and leave the window of the web site. In addition, in some other cases, such as the URL link error, the server temporarily unable to access, firewall intercepting pages or the user accessing some sensitive web pages, etc., some other error pages except 404 Pages will occur in order to prompt the user an error or jump the page to a normal page, etc. The reason why some network error pages are mistaken for vulnerabilities could be in that the traditional vulnerability scanning products can not well identify error pages or 404 Pages in the process of vulnerability judgment, so that the error pages and the 404 Pages are mistaken for vulnerability, which lead to a high rate of vulnerability false positives.

At present, with the development of network technology, error pages or 404 Pages increase with the increase of web sites, and the custom error pages or custom 404 Pages of the web sites also increase dramatically; moreover, each website may set different error pages or 404 Pages. Therefore, in the vulnerability scanning process, a problem urgently to be solved is how to identify whether the vulnerability really exists or it is an error page or a 404 Page, so as to reduce false positive of vulnerability and improve the user experience when using vulnerability scanning products.

### SUMMARY OF THE INVENTION

In view of the above problems, the present invention is proposed to provide a method for detecting web pages and a scanning engine to overcome the above problems or at least partially solve or relieve the above problems.

According to one aspect of the present invention, there is provided a method for detecting web pages, which comprises: crawling the URL or content of a target web site, determining the web page of the web site by a returned result, and accessing the web page; judging whether the accessed web page conforms to at least one of the following rules: a general exception page rule, a custom exception page rule and a custom exception page behavior rule; if so, determining the accessed web page as an exception page; wherein, the general exception page rule is used to determine whether the web page is an exception page according to status codes or contents of the web page, the custom exception page rule is used to determine whether the web page is an exception page according to exception page keyword(s) extracted from the web page, and the custom exception page behavior rule is used to determine whether the web page is an exception page according to a defined behavior of accessing exception pages.

According to another aspect of the present invention, there is provided a scanning engine, which comprises: a scanning rule collection module configured to collect at least one of the following rules: a general exception page rule, a custom exception page rule, and a custom exception page behavior rule; a vulnerability detection module configured to judge whether an accessed web page conforms to at least one of the following rules: the general exception page rule, the custom exception page rule, and the custom exception page behavior rule; and a vulnerability verification module configured to determine the accessed web page is an exception page if the determination result of the vulnerability detection module is that the accessed web page conforms to at least one of the rules; wherein, the general exception page rule is used to determine whether the web page is an exception page according to status codes or contents of the web page, the custom exception page rule is used to determine whether the web page is an exception page according to exception page keyword(s) extracted from the web page, and the custom exception page behavior rule is used to determine whether the web page is an exception page according to a defined behavior of accessing exception pages.

According to still another aspect of the present invention, there is provided a computer program, which comprises computer readable codes, wherein when the computer readable codes are operated on a server, the server executes the method for detecting web pages according to any one of claims 1-8.

According to still another aspect of the present invention, there is provided a computer readable medium, in which the computer program according to claim 16 is stored.

Advantages of the present invention are as follows:

In the embodiments of the present invention, it is determined whether an accessed web page is an exception page by judging whether the accessed web page conforms to one or more of the plurality of the detection rules according to the plurality of exception page detection rules. Compared with the prior art, and particularly with the existing vulnerability scanning technology in which the web page is directly reported as a vulnerability without the judgement of the exception page, the present invention is able to accurately judge the exception pages. Further, if this solution of the present invention is applied to the vulnerability scanning process, then it may be possible to effectively determine these pages are exception pages rather than vulnerabilities, thereby avoiding false positives of vulnerabilities effectively and improving the user's experience of vulnerability scanning products.

The above description is merely an overview of the technical solution of the present invention. In order to more clearly understand the technical solution of the present invention to implement in accordance with the content of the specification, and to make the foregoing and other objects, features and advantages of the present invention more apparent, detailed embodiments of the present invention will be provided hereinafter.

### BRIEF DESCRIPTION OF THE DRAWINGS

Various other advantages and benefits will become apparent to the person skilled in the art by reading the detailed description of the preferred embodiments hereinafter. The accompanied drawings are only for the purpose of illustrating the preferred embodiments, while not considered as limiting the present invention. Moreover, the same parts are denoted by the same reference symbols throughout the drawings. In the accompanied drawings:

FIG. 1 is a flow chart schematically showing steps of a method for detecting web pages according to a first embodiment of the present invention;

FIG. 2 is a flow chart schematically showing steps of a method for detecting web pages according to a second embodiment of the present invention;

FIG. 3 is a flow chart schematically showing steps of a method for detecting web pages according to a third embodiment of the present invention;

FIG. 4 is a flow chart schematically showing steps of a method for detecting web pages according to a fourth embodiment of the present invention;

FIG. 5 is a block diagram schematically showing a scanning engine according to a fifth embodiment of the present invention;

FIG. 6 is a block diagram schematically showing a server for executing the methods according to the present invention; and

FIG. 7 is a block diagram schematically showing a memory cell, which is used to store or carry program codes for realizing the methods according to the present invention.

### DETAILED DESCRIPTION OF THE EMBODIMENTS

Hereinafter, the present invention will be further described in connection with the drawings and the specific embodiments.

### First Embodiment

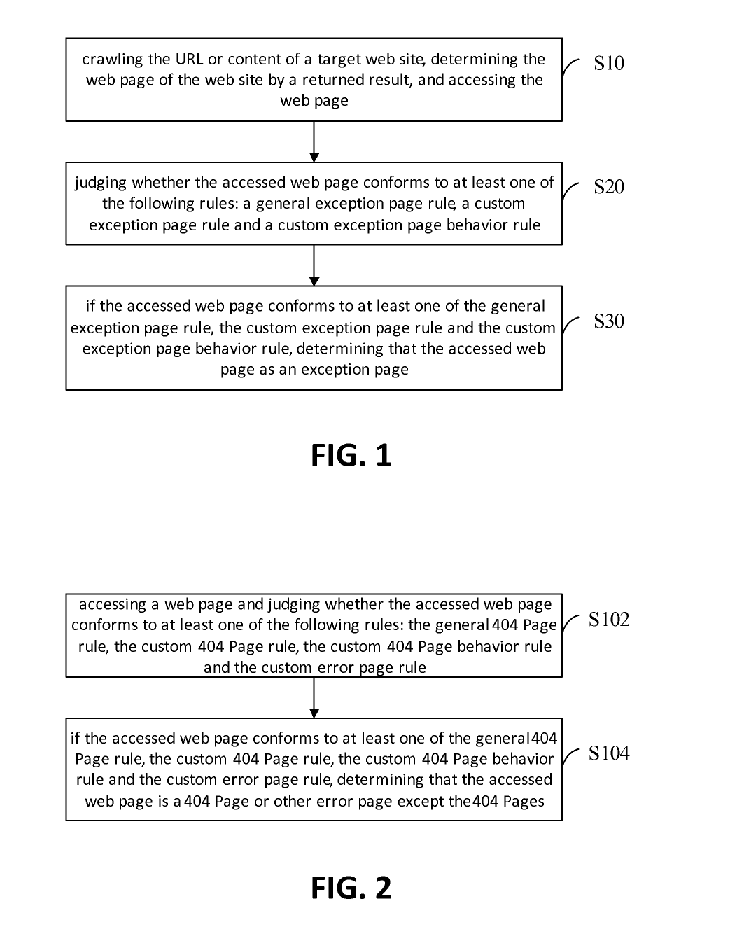

Referring to FIG. 1, which is a flow chart showing steps of a method for detecting web pages according to the first embodiment of the present invention.

The method for detecting web pages of the present embodiment may include the following steps.

S10: crawling the URL or content of a target web site, determining the web page of the web site by a returned result, and accessing the web page.

The crawl of the URL (Uniform Resource Locator) or the content of the target web site may be realized by the Spider technology or the Crawler technology, the returned result of the Spider or the Crawler can be used to judge whether it is a web page of a web site, if so, access the web page.

S20: judging whether the accessed web page conforms to at least one of the following rules: a general exception page rule, a custom exception page rule and a custom exception page behavior rule.

Wherein, the general exception page rule is used to determine whether the web page is an exception page according to status codes or contents of the web page, the custom exception page rule is used to determine whether the web page is an exception page according to exception page keyword(s) extracted from the web page, and the custom exception page behavior rule is used to determine whether the web page is an exception page according to a defined behavior of accessing exception pages.

S30: if the accessed web page conforms to at least one of the general exception page rule, the custom exception page rule and the custom exception page behavior rule, determining that the accessed web page as an exception page.

In this embodiment, it is determined whether an accessed web page is an exception page by judging whether the accessed web page conforms to one or more of the plurality of the detection rules according to the plurality of exception page detection rules. Compared with the prior art, and particularly with the existing vulnerability scanning technology in which the web page is directly reported as a vulnerability without the judgement of the exception page, the present embodiment is able to improve the accuracy of vulnerability judgment and reduce the false positive rate of the vulnerability.

### Second Embodiment

Referring to FIG. 2, which is a flow chart showing steps of a method for detecting web pages according to the second embodiment of the present invention.

This embodiment is a further preferred solution of the first embodiment. In this embodiment, exception pages include 404 Pages and other error pages except 404 Pages. Correspondingly, the general exception page rule includes a general 404 Page rule, the custom exception page rule includes a custom 404 Page rule and a custom error page rule, and the custom exception page behavior rule customizes 404 Page behavior rule.

The method for detecting web pages in this embodiment includes the following steps.

S102: accessing a web page and judging whether the accessed web page conforms to at least one of the following rules: the general 404 Page rule, the custom 404 Page rule, the custom 404 Page behavior rule and the custom error page rule.

Wherein, the general 404 Page rule is used to determine whether a web page is a 404 Page according to status codes or contents of the web page, the custom 404 Page rule is used to determine whether a web page is a 404 Page according to 404 keyword(s) extracted from the web page, the custom 404 Page behavior rule is used to determine whether a web page is a 404 Page according to a defined behavior of accessing 404 Pages, and the custom error page rule is used to determine whether a web page belongs to other error pages except 404 Pages according to error web page keyword(s) extracted from the web page.

S104: if the accessed web page conforms to at least one of the general 404 Page rule, the custom 404 Page rule, the custom 404 Page behavior rule and the custom error page rule, determining that the accessed web page is a 404 Page or other error page except the 404 Pages.

It should be noted that, the custom error page rule would be optional if the detection is mainly directed to the 404 Pages.

With this embodiment, it is determined whether the accessed web page is a 404 Page or other error web page except 404 Pages by judging whether the accessed web page satisfies one or more of the plurality of the detection rules according to the plurality of 404 Page detection rules or error page detection rules. Compared with the prior art, and particularly with the existing vulnerability scanning technology in which 404 Pages or other error web pages are directly reported as vulnerabilities without judgement, the present embodiment is able to make an accurate judgement to the 404 Pages or other error web pages. Furthermore, if this solution of the present embodiment is applied to the vulnerability scanning process, then it may be possible to effectively determine these web pages are non-vulnerability pages, and no vulnerability prompt and no vulnerability report will be made to these pages, thereby avoiding false positives of vulnerabilities and improving the user's experience.

### Third Embodiment

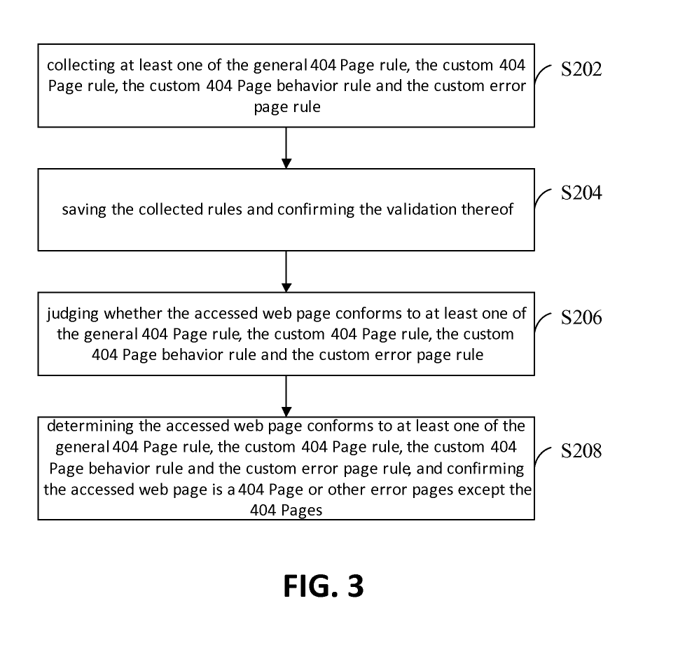

Referring to FIG. 3, which is a flow chart showing steps of a method for detecting web pages according to the third embodiment of the present invention.

The method for detecting web pages of the present embodiment comprises the following steps.

S202: collecting at least one of the general 404 Page rule, the custom 404 Page rule, the custom 404 Page behavior rule and the custom error page rule.

In this embodiment, it may be set to collect all of the above rules. In practice, it may be also possible to collect only part of the above rules as required. In the collection of the above rules, it may be possible to collect, set and use all the rules completely, and then periodically update pre-collected rules at a set time interval; or collect the rules dynamically and update them in real time.

The collected general 404 Page rule may include: judging whether the web page status code is 404, and/or, judging whether the contents of a web page include those of 404 Pages, such as contents of “404 NOT FOUND”, “404 . . . Error”, “Error . . . 404”, “Page . . . not . . . Found”, “File . . . not . . . found”, “Resource . . . not . . . found”, “error . . . request”, “request . . . error”, “Unable to open”, “Unable to find”, “No such file”, “404.html”, “file not found”, “page not found”, “resource not found”, “the web page unavailable” and the like. In other words, the judgment rule of pages in which the web page status code is 404 and/or the web page contents include the 404 Page contents would be collected as a general 404 Page rule upon collection. The general 404 Page rule includes the used 404 Page judgment rules in the prior art, effectively compatible with the existing 404 Page recognition and judgment technology.

The collected custom 404 Page rule may include: judging whether the web page contents, the web page status code, the HTTP (HyperText Transfer Protocol) head of a web page include the extracted 404 keywords. If any one or more of the web page contents, the web page status code, and the HTTP head of the web page include the 404 keywords, the web page is identified to be a 404 Page. Wherein, the 404 keywords are extracted and obtained by comparing the web page contents, the web page status code and the HTTP head of a normal web page of the accessed web site with those of a feedback web page when accessing an inexistent web page of the accessed web site, and usually are contents such as words, images, or links that impossibly exist in the normal web page. That is, upon collection, accessing a normal web page of a web site to extract the web page contents, the web page status code and the HTTP head thereof; accessing an inexistent web page of the web site to extract the web page contents, the web page status code and the HTTP head of a feedback web page; comparing the web page contents, the web page status code and the HTTP head of the normal web page with those of the feedback web page to obtain 404 keyword(s), and collecting judgment rule(s) of pages including the 404 keyword(s) as the custom 404 Page rule. The custom 404 Page rule can effectively identify web pages which essentially are 404 Pages without using the web page status code of 404 or including 404 Page contents, but using other web page status code or in the form of a jumping page. By 404 keywords which are obtained by comparing the normal web page and the feedback error page, the validity of the custom 404 rule is ensured, so as to more accurately and effectively identify and determine 404 Pages.

The collected custom 404 Page behavior rule may include: judging whether the web page contents, the web page status code and HTTP head which are fed back by the web page are consistent/similar with saved web page content, saved web page status code and saved HTTP head when accessing the web page, if they are consistent/similar, the web page is identified to be a 404 Page. That is, web judgment rule(s) of pages including the web page contents, the web page status code and the HTTP head of a feedback web page when accessing an inexistent web page is collected as a custom 404 Page behavior rule. By the collection of the custom 404 Page behavior rule, possible circumstances of 404 Pages are covered as possible, which avoid missing of the 404 Pages to some extent.

The collected custom error page rule may include: judging whether the web page contents, the web page status code, the HTTP head of a web page include the extracted error web page keywords. If any one or more of the web page contents, the web page status code, and the HTTP head of the web page include the error web page keywords, the web page is identified to be an error web page. Wherein, error web page keywords are extracted and obtained by comparing the web page contents, the web page status code and the HTTP head of a normal web page of the accessed web site with those of other error web pages except 404 Pages when accessing an inexistent web page of the web site, and usually are contents other than 404 keywords, such as words, images, or links that impossibly exist in the normal web page. That is, upon collection, accessing a normal web page of a web site to extract the web page contents, the web page status code and the HTTP head thereof; accessing an inexistent web page of the web site to extract the web page contents, the web page status code and the HTTP head of a feedback web page, wherein the feedback web page is an error web page rather than 404 Pages; comparing the web page contents, the web page status code and the HTTP head of the normal web page with those of the feedback web page to obtain error web page keywords, and collecting the judgment rule(s) of pages including the error web page keywords as the custom error page rule. Some web pages are error pages different from the 404 Pages, the custom error page rule can effectively identify these non-404 Pages. By error web page keywords which are obtained by comparing the normal web page and the feedback error page, it can ensure the validity of the custom error page rule, so as to more accurately and effectively identify and judge other error pages except 404 Pages.

By collecting the above rules, it can comprehensively and effectively identify and judge the 404 Pages or the other error pages except the 404 Pages. In addition, the collection way of the above rules is merely illustrative, and a person skilled in the art can use other appropriate ways to collect the rules in practice, for example, manually inputting the rules according to the practical experience or collecting the rules according to historical data.

S204: saving the collected rules and confirming the validation thereof.

The confirmation of the validation of the rules can be implemented by a person skilled in the art in an appropriate manner according to the actual situation, for example, implementing by using the rules to test a web page, and there should not be a limiting in the embodiments of the present invention.

S206: judging whether the accessed web page conforms to at least one of the general 404 Page rule, the custom 404 Page rule, the custom 404 Page behavior rule and the custom error page rule.

Preferably, it may extract the web contents, the web status code and the HTTP head of the accessed web page; and then judge whether the extracted web contents, the extracted web status code or the extracted HTTP head of the accessed web page conforms to one or more of the general 404 Page rule, the custom 404 Page rule, the custom 404 Page behavior rule and the custom error page rule.

S208: determining the accessed web page conforms to at least one of the general 404 Page rule, the custom 404 Page rule, the custom 404 Page behavior rule and the custom error page rule, and confirming the accessed web page is a 404 Page or other error pages except the 404 Pages.

When the accessed web page conforms to one or more of the general 404 Page rule, the custom 404 Page rule and the custom 404 Page behavior rule, it can be confirmed that the accessed web page is a 404 Page; when the accessed web page conforms to the custom error page rule, it can be confirmed that the accessed web page is an error page except the 404 Pages.

It should be noted that the method for detecting web pages of this embodiment can be applied to vulnerability scanning process. When the accessed web page is confirmed to be a 404 Page or other error pages, vulnerability scanning product shall not mistake the web page for vulnerability to prompt or report, that is, without prompting or reporting the 404 Page or other error pages, the false positives of the vulnerability is reduced. While the present invention is not limited thereto, a person skilled in the art should understand that the method for detecting web pages in this embodiment is also applicable to any other situation where the detection of error web page is required.

With this embodiment, it may effectively realize the collection and judgement of 404 Page detection rules and other error page detection rules so as to accurately identify and judge the 404 Pages and the other error pages except the 404 Pages, and when applied to the vulnerability scanning technology, it is possible to effectively avoid the false positives of the vulnerability, thereby increasing the identification accuracy of pages and vulnerabilities and improving the user's experience.

### Fourth Embodiment

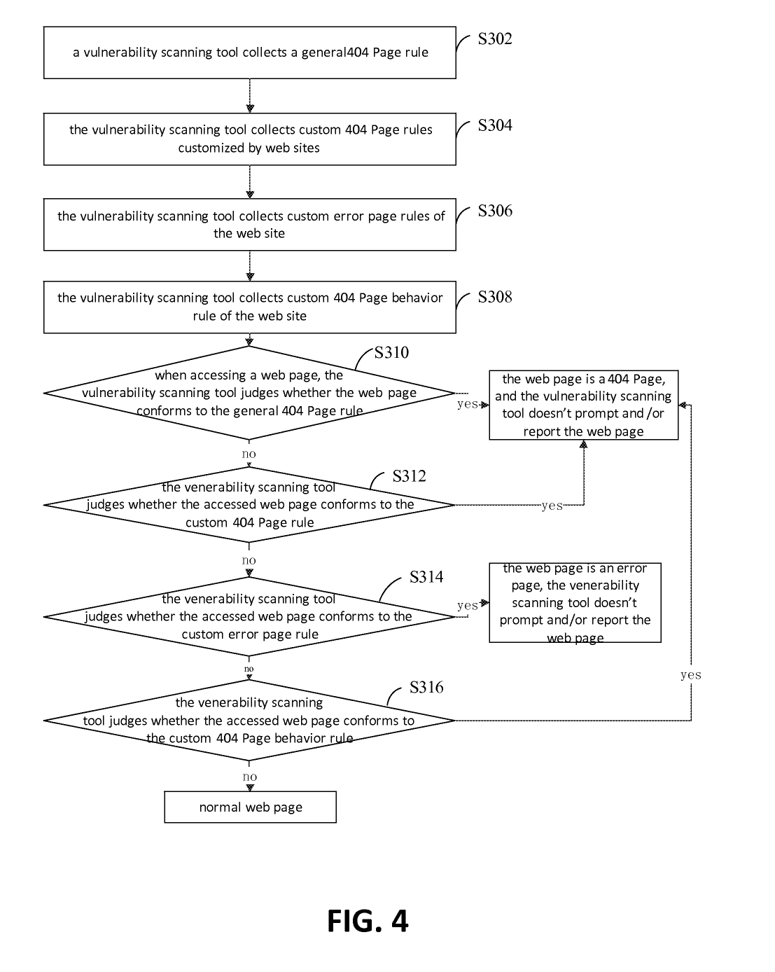

Referring to FIG. 4, it is a flow chart showing steps of a method for detecting web pages according to the fourth embodiment of the present invention.

This embodiment will be explained by way of an example in which a vulnerability scanning tool applies the method for detecting web pages in the vulnerability scanning process. In the prior art, with the increase in the number of web sites, traditional or custom error pages or 404 Pages are also increased dramatically. Wherein, a number of 404 Pages are custom, the returned web page status code is not 404, and thus it is difficult to correctly judge these pages are 404 Pages through judging the web page status code. In addition, some error web pages, such as error pages intercepted by a firewall, cannot be effectively identified and judged. For this kind of situation, the method for detecting web pages of this embodiment can be used to identify and judge, thereby avoiding mistaking 404 Pages or other error pages for vulnerabilities, which may cause false positives of vulnerability by the vulnerability scanning tool.

The method for detecting web pages in this embodiment includes the following steps.

S302: a vulnerability scanning tool collects a general 404 Page rule.

The existing 404 Page judgement rules are collectively known as the general 404 Page rule, including commonly used 404 Page judgement rules, such as web page status code being 404, web page contents including “404 NOT FOUND”, “page NOT FOUND” and the like.

After collecting conventional 404 rules or custom 404 rules that are adopted by the majority of web sites as the general 404 Page rule, saving the general 404 Page rule, and preferably, further confirming the validity of the general 404 Page rule.

S304: the vulnerability scanning tool collects custom 404 Page rules customized by web sites.

The collection of the custom 404 Page rule includes the collection of the pages and the files of the web sites.

In particular, it may include:

Step a1: accessing a normal page of a web site returned by a Spider or a Crawler, and extracting the web page content as html_ok, the web page status code as http_status_ok, the HTTP head as http_head_ok from the returned web page.

Step b1: accessing an inexistent page of the web site, and extracting the web page content as html_err1, the web page status code as http_status_err1, the HTTP head as http_head_err1 from the returned feedback page.

Wherein, the access of the inexistent page can be realized through appending an inexistent page after a normal page and then accessing the synthesis page. For example, a character string is appended after a normal web page address to generate a new web page address which does not belong to the normal web page address of the web site, and then the web page address is accessed. Of course, there is no limit to this. A person skilled in the art may adopt other manners to access the inexistent page in practice, and it should not be limited in the embodiment of the present invention.

In addition, it may also proceed with extracting the URL (Uniform Resource Locator) of the feedback page.

Step c1: judging whether the http_status_err1 is 404, if it is 404, the general 404 Page rule is conformed, and there is no need to collect custom 404 Page rule additionally; if it is not 404, going to step d1.

Step d1: judging whether the http_status_err1 is a redirect code, such as a code between 300-400, if it is not a redirect code, such as a code not between 300-400, going to step e1; if it is a redirect code, such as code between 300-400, which indicates the web page activates a jump function, then obtaining the redirect page; judging whether the redirect page is obtained, if there is a redirect page, then processing the redirect page, extracting the URL of the redirect page as 404 keywords, or extracting 404 keywords from the page contents of the redirect page to save as a custom 404 Page rule; if there is no redirect page, then comparing the web page content html_err1 and html_ok, the web page status codes http_status_ok and http_status_err1, the HTTP heads of the web page http_head_ok and http_head_err1, and then extracting 404 keywords to save as custom 404 Page rules.

404 keywords can be one or more of texts, images, and links, etc., and a plurality of 404 keywords may be extracted. The plurality of 404 keywords may be saved as custom 404 Page rules, or merely a part of the 404 keywords, such as one of the 404 keywords, may be saved as a custom 404 Page rule. For example, it is possible to select 404 keywords that occupy the least space, or to select 404 keywords that are the shortest when 404 keywords are formed in a plurality of texts, so as to improve the collection efficiency of the custom 404 Page rule and identification efficiency of 404 Pages.

Step e1: if it is not a jump page, judging whether the web page content html_err1 conforms to the general 404 Page rule, if yes, then exiting; if not, then comparing the web page content html_err1 and html_ok, the web page status codes http_status_ok and http_status_err1, the HTTP heads of the web page http_head_ok and http_head_err1, and then extracting 404 keywords to save as a custom 404 Page rule.

Step S306: the vulnerability scanning tool collects custom error page rules of the web site.

The Collection of the custom error page rule includes the collection of error pages except the 404 Pages such as web pages intercepted by a firewall, collapsed web pages, web pages being unable to access, etc.

In particular, it may include:

Step a2: accessing a normal page of a web site returned by a Spider or a Crawler, and extracting the web page content as html_ok, the web page status code as http_status_ok, the HTTP head as http_head_ok from the returned web page.

Step b2: accessing an inexistent file of the web site, and extracting the web page content as html_err1, the web page status code as http_status_err1, the HTTP head as http_head_err1 from the returned feedback page, wherein the feedback page is an error page except the 404 Pages.

Wherein, the access of the inexistent page can be realized through appending an inexistent page after a normal page and then accessing the synthesis page. For example, a character string is appended after a normal web page address to generate a new web page address which does not belong to the normal web page address of the web site, and then the web page address is accessed. Of course, there is no limit to this. A person skilled in the art may adopt other manners to access the inexistent page in practice, and it should not be limited in the embodiment of the present invention.

In addition, it may also proceed with extracting the URL of the feedback page.

Step c2: judging whether the http_status_err1 is 404, if it is 404, the general 404 Page rule is conformed, and there is no need to collect custom error page rule additionally; if it is not 404, going to step d2.

Step d2: judging whether the http_status_err1 is a redirect code, such as a code between 300-400, if it is not a redirect code, such as a code not between 300-400, going to step e2; if it is a redirect code, such as a code between 300-400, which indicates the web page activates a jump function, and then obtaining the redirect page; judging whether the redirect page is obtained, if there is a redirect page, then processing the redirect page, extracting keywords of the error page to save as a custom error page rule of web site; if there is no redirect page, then comparing the web page content html_err1 and html_ok, the web page status code http_status_ok and http_status_err1, the HTTP head of the web page http_head_ok and http_head_err1, and then extracting error web page keywords to save as custom error page rules of the web site.

Similar to the 404 keywords, the error page keywords can also be one or more of texts, images, and links, etc., and a plurality of error page keywords can be extracted. The plurality of error page keywords may be saved as custom error page rules, or merely a part of the error page keywords, such as one of the error page keywords, may be saved as a custom error page rule. For example, it is possible to select error page keywords that occupy the least space, or to select error page keywords that are the shortest when error keywords are formed in a plurality of texts, so as to improve the collection efficiency of the custom error page rule and identification efficiency of error pages.

Step e2: if it is not a jump page, judging whether the web page content html_err1 conforms to the general 404 Page rule, if yes, then exiting; If not, then comparing the web page content html_err1 and html_ok, the web page status code http_status_ok and http_status_err1, the HTTP head of the web page http_head_ok and http_head_err1, and then extracting error page keywords to save as a custom error page rule of the web site.

Step S308: the vulnerability scanning tool collects custom 404 Page behavior rule of the web site.

That is, collecting behavior information of web pages conforming to the 404 Page rule and/or the custom 404 Page rule.

In particular, it may include:

Step a3: accessing an inexistent page of the web site, and extracting the web page content of as html_err1, the web page status code as http_status_err1, the HTTP head as http_head_err1 from the returned feedback page, and saving.

Step b3: judging whether the http_status_err1 is 404, if it is 404, the general 404 Page rule is conformed, and there is no need to extract custom 404 Page behavior rule additionally; if it is not 404, going to step c3.

Step c3: judging whether the http_status_err1 is a redirect code, such as a code between 300-400, if it is not a redirect code, such as a code not between 300-400, going to step d3; if it is a redirect code, such as a code between 300-400, which indicates the web page activates a jump function, and then obtaining the redirect page; judging whether the redirect page is obtained, if there is a redirect page, then processing the redirect page, extracting the web page content as html_err2, the web page status code as http_status_err2, the HTTP head of the feedback page as http_head_err2 to save as a custom 404 Page behavior rule of the web site; if there is no redirect page, then saving the web page content html_err1, the web page status code http_status_err1, the HTTP head http_head_err1 as a custom 404 Page behavior rule of the web site.

Step d3: if it is not a jump page, then judging whether the web page content html_err1 conforms to the general 404 rule, if yes, then exiting; if not, then saving the web page content html_err1, the web page status code http_status_err1, the HTTP head http_head_err1 as a custom error page rule of the web site.

It should be noted that the above steps S302-S308 can be executed in no particular order and can be executed in parallel during the practical execution.

Step S310: when accessing a web page, the vulnerability scanning tool judges whether the web page conforms to the general 404 Page rule, if yes, then the web page is a 404 Page, and the vulnerability scanning tool doesn't prompt and/or report the web page; if not, then proceeding to step S312.

In particular, the step may include:

Step a4: accessing a web page and extracting the web page content as html, the web page status code as http_status, and the web page HTTP head as http_head.

Step b4: judging whether the http_status is 404, if yes, then determining the web page is a 404 Page, and the detection process of the web page being exited; If not, repeatedly determining whether the web page conforms to the general 404 Page rule according to the http_status or the web page content html or the web page HTTP head http_head, if yes, going to steps c4; if not, proceeding to step S312.

Step c4: if the general 404 Page rule is conformed, then indicating that the web page is a 404 Page, the web page detection process being exited, and the vulnerability scanning tool not prompting and/or reporting the web page.

S312: the venerability scanning tool judges whether the accessed web page conforms to the custom 404 Page rule; if yes, indicating that it is a 404 Page, and the venerability scanning tool doesn't prompt and/or report the web page; if not, it proceeds to step S314.

It can be known from the step S310, the web page status code of the accessed web page is not 404 and the general 404 Page rule is not conformed; then it is repeatedly judged whether the custom 404 Page rule is conformed according to the http_status or the web page content html or the web page HTTP head http_head; if the custom 404 Page rule is conformed, then it is indicated that the web page is a 404 Page, and the web page detection process is exited, and the venerability scanning tool doesn't prompt and/or report the web page; if not, it proceeds to step S314.

S314: the venerability scanning tool judges whether the accessed web page conforms to the custom error page rule; if yes, it is indicated that the web page is an error page, the venerability scanning tool doesn't prompt and/or report the web page; if not, it proceeds to step S316.

It can be known from the step S312, the web page status code of the accessed web page is not 404, and neither the general 404 Page rule nor the custom 404 Page rule is conformed; then it is repeatedly judged whether the custom error page rule is conformed according to the http_status or the web page content html or the HTTP head http_head; if the custom error page rule is conformed, then it is indicated that the web page is a error web page except the 404 Pages, the web page detection process is exited, and the venerability scanning tool doesn't prompt and/or report the web page; if not, it proceeds to step 316.

S316: the venerability scanning tool judges whether the accessed web page conforms to the custom 404 Page behavior rule; if yes, it is indicated that the web page is a 404 Page, the venerability scanning tool doesn't prompt and/or report the web page; if not, it is indicated that the web page is a normal web page.

It can be known from S314, the web page status code of the accessed web page is not 404, and none of the general 404 Page rule, the custom 404 Page rule and the custom error page rule is conformed; then it is repeatedly judged that whether the custom 404 Page behavior rule (for example, the web page status code has a similar size with the web page content or is similar with the redirect page and etc.) is conformed according to the http_status or the web page content html or the HTTP head http_head; if the custom 404 Page behavior rule is conformed, then it is indicated that the web page is a 404 Page, and the web page detection process is exited; if not, it is indicated that the web page would be a normal page.

It should be noted that the above determination processes are illustrative, and it should be understand by a person skilled in the art that, in practice, the judgement of that whether the web page conforms to the rules of the steps S310-S316 can be performed in an arbitrary order, for example, judging whether the custom error page rule is conformed can be firstly performed, or judging whether the custom 404 Page rule is conformed can be firstly performed, etc.

With this embodiment, it may effectively realize the collection of detection rules of the 404 Pages or the other error pages, as well as accurate identification and judgement of the 404 Pages or the other error pages, so as to more accurately and effectively identify the 404 Pages, the other error web pages or the correct pages, effectively avoiding false positives of the vulnerability by the vulnerability scanning tool.

### Fifth Embodiment

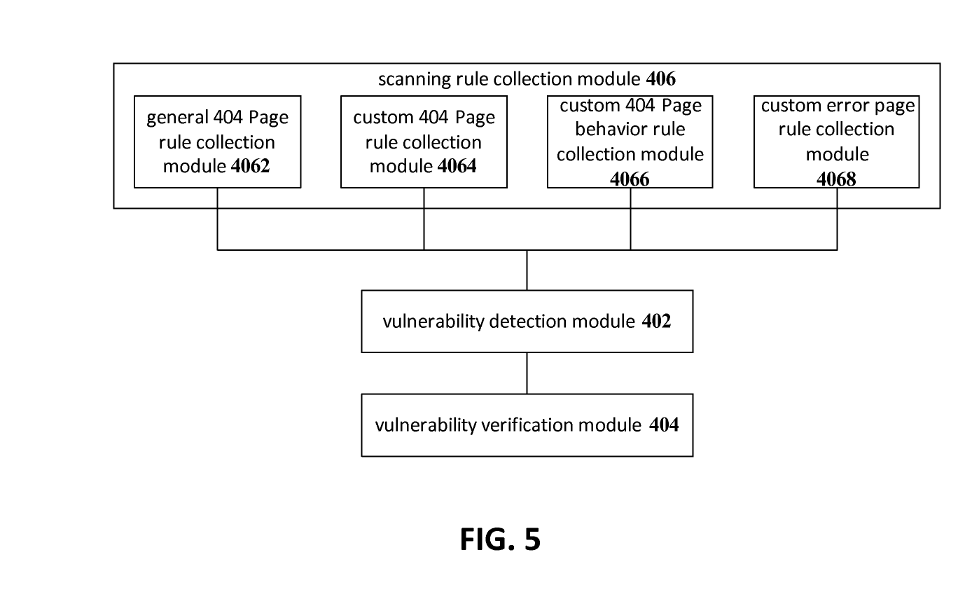

Referring to FIG. 5, which shows a block diagram of a scanning engine according to the fifth embodiment of the present invention.

The scanning engine of this embodiment includes: a scanning rule collection module 406 configured to collect at least one of the following rules: a general exception page rule, a custom exception page rule, and a custom exception page behavior rule; a vulnerability detection module 402 configured to judge whether an accessed web page conforms to at least one of the following rules: the general exception page rule, the custom exception page rule, and the custom exception page behavior rule, wherein, the general exception page rule is used to determine whether the web page is an exception page according to status codes or contents of the web page, the custom exception page rule is used to determine whether the web page is an exception page according to exception page keyword(s) extracted from the web page, and the custom exception page behavior rule is used to determine whether the web page is an exception page according to a defined behavior of accessing exception pages; a vulnerability verification module 404 configured to determine that the accessed web page is an exception page if the determination result of the vulnerability detection module 402 is that the accessed web page conforms to at least one of the rules.

Preferably, the exception page includes 404 Pages and other error pages except the 404 Pages; the general exception page rule includes a general 404 Page rule, the custom exception page rule includes a custom 404 Page rule, the custom exception page behavior rule includes a custom 404 Page behavior rule; wherein, the general 404 Page rule is used to determine whether a web page is a 404 Page according to status codes or contents of the web page, the custom 404 Page rule is used to determine whether a web page is a 404 Page according to 404 keyword(s) extracted from the web page, and the custom 404 Page behavior rule is used to determine whether a web page is a 404 Page according to a defined behavior of accessing 404 Pages.

Preferably, the custom exception page rule further includes a custom error page rule used to determine whether a web page is one of other error web pages except 404 Pages according to error page keyword(s) extracted from the web page.

Preferably, the scanning rule collection module 406 of this embodiment is configured to collect at least one of rules: the general 404 Page rule, the custom 404 Page rule, the custom 404 Page behavior rule, and the custom error page rule.

Preferably, the scanning rule collection module 406 includes at least one of the following: a general 404 Page rule collection module 4062 configured to collect judgment rule(s) of pages in which the web page status code is 404 and/or the web page content includes 404 Page content as the general 404 Page rule; a custom 404 Page rule collection module 4064 configured to access a normal web page of a web site to extract web page content, web page status code and HTTP head thereof; to access an inexistent web page of the web site to extract web page content, web page status code and HTTP head of a feedback web page; to compare the web page content, the web page status code and the HTTP head of the normal web page with those of the feedback web page to obtain 404 keyword(s), and collect judgment rule(s) of pages including the 404 keyword(s) as the custom 404 Page rule; a custom 404 Page behavior rule collection module 4066 configured to access an inexistent web page and collect judgment rule(s) of page(s) including the web page content, web page status code and HTTP head of a feedback web page as the custom 404 Page behavior rule; and a custom error page rule collection module 4068 configured to access a normal web page of a web site to extract web page content, web page status code and HTTP head thereof; to access an inexistent web page of the web site to extract web page content, web page status code and HTTP head of a feedback web page, wherein the feedback web page is an error web page other than a 404 Page; to compare the web page content, the web page status code and the HTTP head of the normal web page with those of the feedback web page to obtain error web page keyword(s), and collect judgment rule(s) of pages including the error web page keyword(s) as the custom error page rule.

Preferably, the custom 404 Page rule collection module 4064, when accessing an inexistent web page of the web site to extract web page content, web page status code and HTTP head of a feedback web page, may judge whether the returned web page status code of the feedback web page is 404 when accessing the inexistent web page; if not, then may judge whether the web page status code of the feedback web page is a redirect code; if it is a redirect code, may judge whether there is a redirect page, if yes, then may obtain the redirect page to be the feedback web page, and may extract the URL, the web page content, the web page status code and the HTTP head of the redirect page.

Preferably, the custom error page rule collection module 4068, when accessing an inexistent web page of the web site to extract web page content, web page status code and HTTP head of a feedback web page, may judge whether the returned web page status code of the web page is 404 when accessing the inexistent web page; if not, then may judge whether the web page status code of the feedback web page is a redirect code; if it is a redirect code, may judge whether there is a redirect page, if yes, then may obtain the redirect page to be the feedback web page and extract the URL, the web page content, the web page status code and the HTTP head of the redirect page.

Preferably, the vulnerability detection module 402 may be configured to extract the web page content, the web page status code and the HTTP head of the accessed web page; judge whether the web page content, the web page status code or the HTTP head of the accessed web page conforms to at least one of the following rules: the general 404 Page rule, the custom 404 Page rule, the custom 404 Page behavior rule and the custom error page rule.

Preferably, the scanning engine in this embodiment is set on a server side for vulnerability scanning; the scanning engine further includes: a result execution module (not shown in the figure), configured not to prompt or not to report the exception page as a vulnerability page after the vulnerability verification module 404 determines that the accessed web page is an exception page.

The scanning engine in this embodiment is able to realize the corresponding method for detecting web pages of the plurality of method embodiments as discussed above, and has advantageous effects of the corresponding method embodiments. Therefore the description thereof will be omitted herein.

The embodiment of the present invention provides a solution to identify correctly whether a web page of a web site is an error page or a 404 Page. In the current internet age that humanity and user experience are emphasized, there will be more and more web sites using custom error pages or the 404 Pages. By the solution of the embodiment of the present invention, it is able to be well judged that whether a web page is an error web page or a 404 Page, and the solution can accurately determine vulnerability, thus reducing false positives and improving the user's experience.

The embodiments of the present invention can be implemented in any device(s) supporting imagine processing, crawling of Internet content and rendering. The device includes but is not limited to personal computer, cluster server, mobile phone, workstation, embedded system, game console, TV, set-top box or any other computing device supporting computer graphics and content displaying. These devices may include but are not limited to a device which has one or more processor and memory for executing and storing instructions. These devices may include software, firmware and hardware. The software may include one or more application and operating system. The hardware may include but not be limited to processor, memory and display.

The various embodiments in the specification have been explained step by step. Each of the embodiments has only emphasized the differences from others, and the same or similar explanations between embodiments could be made reference to each other. As to the device embodiment of the scanning engine, it is substantially similar to the method embodiments, the description thereof is relatively brief. As for the related parts, reference may be made to the corresponding description of the method embodiments.

Each of components according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the members of the scanning engine according to the embodiments of the present invention. The present invention may further be implemented as equipment or device programs (for example, computer programs and computer program products) for executing some or all of the methods as described herein. The programs for implementing the present invention may be stored in the computer readable medium, or have a form of one or more signal. Such a signal may be downloaded from the internet web sites, or be provided in carrier, or be provided in other manners.

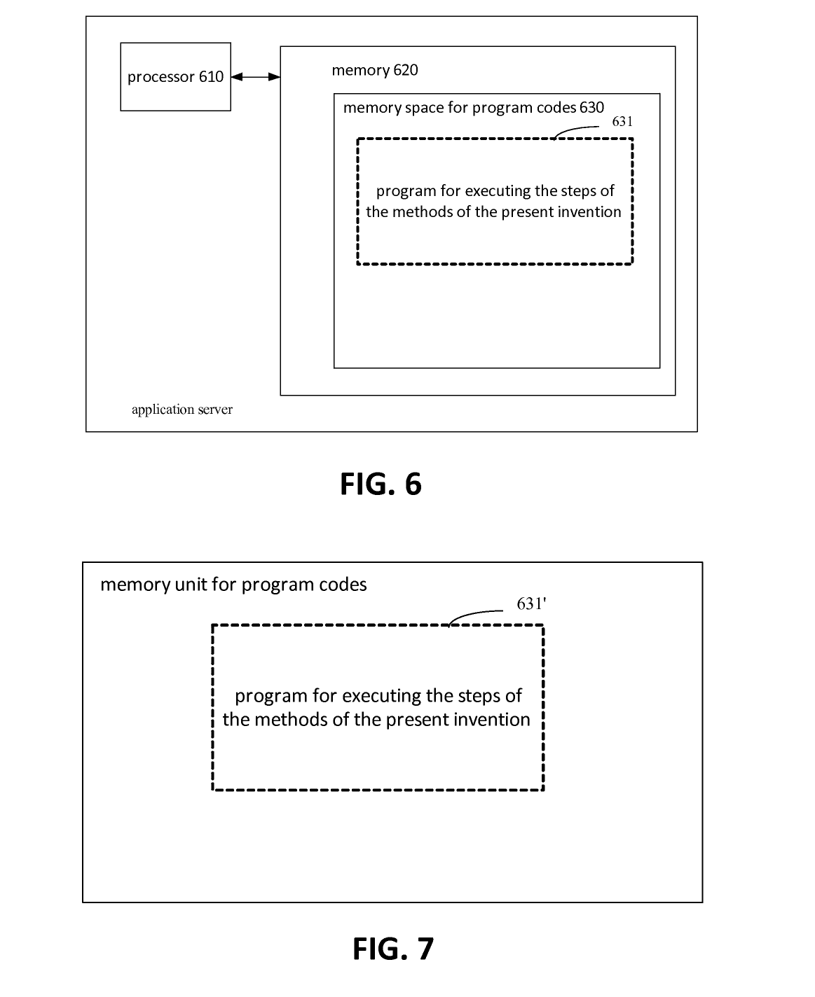

For example, FIG. 6 schematically shows a server for implementing the method for detecting web pages according to the present invention, such as an application server. Traditionally, the server comprises a processor 610 and a computer program product or a computer readable medium in form of a memory 620. The memory 620 may be electronic memories such as flash memory, EEPROM (Electrically Erasable Programmable Read-Only Memory), EPROM, hard disk or ROM. The memory 620 has a memory space 630 for executing program codes 631 of any steps of the above methods. For example, the memory space 630 for program codes may comprise respective program codes 631 for implementing the various steps in the above mentioned methods. These program codes may be read from or be written into one or more computer program products. These computer program products comprise program code carriers such as hard disk, compact disk (CD), memory card or floppy disk. These computer program products are usually the portable or stable memory cells as shown in reference FIG. 7. The memory cells may be provided with memory sections, memory spaces, etc., similar to the memory 620 of the server as shown in FIG. 6. The program codes may be compressed in an appropriate form. Usually, the memory cell includes computer readable codes 631′ which can be read by processors such as 610. When these codes are operated on the server, the server may execute each step as described in the above methods.

The terms “one embodiment”, “an embodiment” or “one or more embodiment” used herein means that, the particular feature, structure, or characteristic described in connection with the embodiments may be included in at least one embodiment of the present invention. In addition, it should be noticed that, for example, the wording “in one embodiment” used herein is not necessarily always referring to the same embodiment.

A number of specific details have been described in the specification provided herein. However, it should be understood that the embodiments of the present invention may be practiced without these specific details. In some examples, in order not to confuse the understanding of the specification, the known methods, structures and techniques are not shown in detail.

It should be noticed that the above-described embodiments are intended to illustrate but not to limit the present invention, and alternative embodiments can be devised by the person skilled in the art without departing from the scope of claims as appended. In the claims, any reference symbols between brackets should not form a limit of the claims. The wording “comprising/comprise” does not exclude the presence of elements or steps not listed in a claim. The wording “a” or “an” in front of element does not exclude the presence of a plurality of such elements. The present invention may be achieved by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

It should also be noticed that the language used in the present specification is chosen for the purpose of readability and teaching, rather than selected in order to explain or define the subject matter of the present invention. Therefore, it is obvious for an ordinary skilled person in the art that modifications and variations could be made without departing from the scope and spirit of the claims as appended. For the scope of the present invention, the disclosure of the present invention is illustrative but not restrictive, and the scope of the present invention is defined by the appended claims.

1. A method for detecting web pages, comprising:
crawling the URL or content of a target web site, determining the web page of the web site by a returned result, and accessing the web page;
judging whether the accessed web page conforms to at least one of the following rules: a general exception page rule, a custom exception page rule and a custom exception page behavior rule;
if so, determining the accessed web page as an exception page;
wherein, the general exception page rule is used to determine whether the web page is an exception page according to status codes or contents of the web page, the custom exception page rule is used to determine whether the web page is an exception page according to exception page keyword(s) extracted from the web page, and the custom exception page behavior rule is used to determine whether the web page is an exception page according to a defined behavior of accessing exception pages.

2. The method according to claim 1, wherein the exception pages comprise 404 Pages and other error pages except 404 Pages;
the general exception page rule includes a general 404 Page rule, the custom exception page rule includes a custom 404 Page rule, the custom exception page behavior rule includes a custom 404 Page behavior rule; wherein the general 404 Page rule is used to determine whether a web page is a 404 Page according to status codes or contents of the web page, the custom 404 Page rule is used to determine whether a web page is a 404 Page according to 404 keyword(s) extracted from the web page, and the custom 404 Page behavior rule is used to determine whether a web page is a 404 Page according to a defined behavior of accessing 404 Pages.

3. The method according to claim 2, wherein the custom exception page rule further includes a custom error page rule used to determine whether a web page belongs to other error web pages except 404 Pages according to error web page keyword(s) extracted from the web page.

4. The method according to claim 3, wherein, before judging whether the accessed web page conforms to at least one of the following rules: a general exception page rule, a custom exception page rule, a custom exception page behavior rule, the method further comprises:
collecting at least one of the general 404 Page rule, the custom 404 Page rule, the custom 404 Page behavior rule and the custom error page rule.

5. The method according to claim 4, wherein,
the step of collecting the general 404 Page rule comprises: collecting judgment rule of pages in which the web page status code is 404 and/or the web page content includes 404 Page content as the general 404 Page rule;
the step of collecting the custom 404 Page rule comprises: accessing a normal web page of a website to extract web page content, web page status code and HTTP head thereof; accessing an inexistent web page of the website to extract web page content, web page status code and HTTP head of a feedback web page; comparing the web page content, the web page status code and the HTTP head of the normal web page with those of the feedback web page to obtain 404 keyword(s), and collecting judgment rule of pages including the 404 keyword(s) as the custom 404 Page rule;
the step of collecting the custom 404 Page behavior rule comprises: accessing an inexistent web page and collecting judgment rule of pages including web page content, web page status code and HTTP head of a feedback web page as the custom 404 Page behavior rule; and
the step of collecting the custom error page rule comprises: accessing a normal web page of a web site to extract web page content, web page status code and HTTP head thereof; accessing an inexistent web page of the web site to extract web page content, web page status code and HTTP head of a feedback web page, wherein the feedback web page is an error web page other than a 404 Page; comparing the web page content, the web page status code and the HTTP head of the normal web page with those of the feedback web page to obtain error web page keyword(s), and collecting judgment rule of pages including the error web page keyword(s) as the custom error page rule.

6. The method according to claim 5, wherein,
the step of accessing an inexistent web page of the web site to extract web page content, web page status code and HTTP head of a feedback web page in collecting the custom 404 Page rule comprises: judging whether the returned web page status code of the feedback web page is 404 when accessing the inexistent web page; if not, then judging whether the web page status code of the feedback web page is a redirect code; if it is a redirect code, judging whether there is a redirect page, if there is a redirect page, then obtaining the redirect page to be the feedback web page, and extracting the URL, the web page content, the web page status code and the HTTP head of the redirect page; and
the step of accessing an inexistent web page of the web site to extract web page content, web page status code and HTTP head of a feedback web page in collecting the custom error page rule comprises: judging whether the returned web page status code of the feedback web page is 404 when accessing the inexistent web page; if not, then judging whether the web page status code of the feedback web page is a redirect code; if it is a redirect code, judging whether there is a redirect page, if there is a redirect page, then obtaining the redirect page to be the feedback web page, and extracting the URL, the web page content, the web page status code and the HTTP head of the redirect page.

7. The method according to claim 1, wherein the step of judging whether the accessed web page conforms to at least one of the following rules: a general exception page rule, a custom exception page rule and a custom exception page behavior rule comprises:
extracting web page content, web page status code and HTTP head of the accessed web page; and
judging whether the web page content, the web page status code or the HTTP head of the accessed web page conforms to at least one of the following rules: the general exception page rule, the custom exception page rule and the custom exception page behavior rule.

8. The method according to claim 1, wherein
the method for detecting web pages is applied to a vulnerability scanning process; and
after determining that the accessed web page is an exception page, the method further comprises: not prompting or not reporting the exception page as a vulnerability web page.

9. A scanning engine, comprising:
at least one processor to execute:
a scanning rule collection module configured to collect at least one of the following rules: a general exception page rule, a custom exception page rule, and a custom exception page behavior rule;
a vulnerability detection module configured to judge whether an accessed web page by a client conforms to at least one of the following rules: the general exception page rule, the custom exception page rule, and the custom exception page behavior rule; and
a vulnerability verification module configured to determine the accessed web page is an exception page if the determination result of the vulnerability detection module is that the accessed web page conforms to at least one of the rules;
wherein, the general exception page rule is used to determine whether the web page is an exception page according to status codes or contents of the web page, the custom exception page rule is used to determine whether the web page is an exception page according to exception page keyword(s) extracted from the web page, and the custom exception page behavior rule is used to determine whether the web page is an exception page according to a defined behavior of accessing exception pages.

10. The scanning engine according to claim 9, wherein the exception pages comprise 404 Pages and other error pages except 404 Pages;
the general exception page rule includes a general 404 Page rule, the custom exception page rule includes a custom 404 Page rule, the custom exception page behavior rule includes a custom 404 Page behavior rule; wherein the general 404 Page rule is used to determine whether a web page is a 404 Page according to status codes or contents of the web page, the custom 404 Page rule is used to determine whether a web page is a 404 Page according to 404 keyword(s) extracted from the web page, and the custom 404 Page behavior rule is used to determine whether a web page is a 404 Page according to a defined behavior of accessing 404 Pages.

11. The scanning engine according to claim 10, wherein the custom exception page rule further includes a custom error page rule used to determine whether a web page belongs to other error web pages except 404 Pages according to error web page keyword(s) extracted from the web page.

12. The scanning engine according to claim 11, wherein,
the scanning rule collection module is specifically configured to collect at least one of the general 404 Page rule, the custom 404 Page rule, the custom 404 Page behavior rule and the custom error page rule.

13. The scanning engine according to claim 12, wherein the scanning rule collection module includes at least one of the following:
a general 404 Page rule collection module configured to collect judgment rule of pages in which the web page status code is 404 and/or the web page content includes 404 Page content as the general 404 Page rule;
a custom 404 Page rule collection module configured to access a normal web page of a web site to extract web page content, web page status code and HTTP head thereof; access an inexistent web page of the web site to extract web page content, web page status code and HTTP head of a feedback web page; compare the web page content, the web page status code and the HTTP head of the normal web page with those of the feedback web page to obtain 404 keyword(s), and collect judgment rule of pages including the 404 keyword(s) as the custom 404 Page rule;
a custom 404 Page behavior rule collection module configured to access an inexistent web page and collect judgment rule of pages including the web page content, web page status code and HTTP head of a feedback web page as the custom 404 Page behavior rule; and
a custom error page rule collection module configured to access a normal web page of a web site to extract web page content, web page status code and HTTP head thereof; access an inexistent web page of the web site to extract web page content, web page status code and HTTP head of a feedback web page, wherein the feedback web page is an error web page other than a 404 Page; compare the web page content, the web page status code and the HTTP head of the normal web page with those of the feedback web page to obtain error web page keyword(s), and collect judgment rule of pages including the error web page keyword(s) as the custom error page rule.

14. The scanning engine according to claim 13, wherein,
the custom 404 Page rule collection module, when accessing an inexistent web page of the web site to extract web page content, web page status code and HTTP head of a feedback web page, judges whether the returned web page status code of the feedback web page is 404 when accessing the inexistent web page; if not, then judges whether the web page status code of the feedback web page is a redirect code; if it is a redirect code, judges whether there is a redirect page, if there is a redirect page, then obtains the redirect page to be the feedback web page, and extracts the URL, the web page content, the web page status code and the HTTP head of the redirect page; and
the custom error page rule collection module, when accessing an inexistent web page of the web site to extract web page content, web page status code and HTTP head of a feedback web page, judges whether the returned web page status code of the web page is 404 when accessing the inexistent web page; if not, then judges whether the web page status code of the feedback web page is a redirect code; if it is a redirect code, judges whether there is a redirect page, if there is a redirect page, then obtains the redirect page to be the feedback web page, and extracts the URL, the web page content, the web page status code and the HTTP head of the redirect page.

15. The scanning engine according to claim 9, wherein, the scanning engine is set on a server side for vulnerability scanning; and
the scanning engine further comprises: a result execution module configured not to prompt or not to report the exception page as a vulnerability page after the vulnerability verification module determines that the accessed web page is an exception page.

16-17. (canceled)

18. A non-transitory computer readable medium having instructions stored thereon that, when executed by at least one processor, cause the at least one processor to perform operations for detecting web pages comprising:
crawling the URL or content of a target web site, determining the web page of the web site by a returned result, and accessing the web page;
judging whether the accessed web page conforms to at least one of the following rules: a general exception page rule, a custom exception page rule and a custom exception page behavior rule;
if so, determining the accessed web page as an exception page;
wherein, the general exception page rule is used to determine whether the web page is an exception page according to status codes or contents of the web page, the custom exception page rule is used to determine whether the web page is an exception page according to exception page keyword(s) extracted from the web page, and the custom exception page behavior rule is used to determine whether the web page is an exception page according to a defined behavior of accessing exception pages.
